(19) United States
(12) Patent Application Publication
(10) Pub. No.: US 2018/0186281 A1
(43) Pub. Date: Jul. 5, 2018

(54) Detachable Magnetic LED Housing and USB Power Source

(71) Applicant: Maxton Group, Inc., Port Orange, FL (US)

(72) Inventor: Aaron Becker, Port Orange, FL (US)

(73) Assignee: Maxton Group, Inc., Port Orange, FL (US)

(21) Appl. No.: 15/397,225

(22) Filed: Jan. 3, 2017

(51) Int. Cl. B60Q 1/26; B60Q 1/00; F21S 9/02; F21V 21/096; F21V 21/26; F21V 23/06; F21S 8/10

(52) U.S. Cl. CPC B60Q 1/2615; B60Q 1/0076; F21S 9/02; F21Y 2115/10; F21V 21/26; F21V 23/06; F21S 48/2212; F21V 21/096

(57) ABSTRACT

A Detachable Magnetic LED Housing and USB power source with a base having an aperture for affixation to a vehicle, a recessed pocket in the base for insertion of a removable light module with LED light, the light module has a pivoting clip for engagement to a front portion of the base, the module has a magnetic surface or extension for engagement to metal, and the LED light is controllable through buttons on the face the module. The light is operable in different modes, including white, amber and flashing lights and the base has a charging USB port. The base is electrically engaged to the vehicle power and has a separate rechargeable battery.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of lighting and more particularly to a Detachable Magnetic LED Light and USB power source.

Previous mounted lights on vehicles are either fixed in position, or do not permit stable engagement to the vehicle. Further, lights are not equipped with a magnetic engagement and easel stand for use when disengaged from the vehicle mount.

The preferred embodiments of the present invention solve these problems by creating a removable mountable LED light system that may be set up in different manners to provide task lighting where most needed. Further, they provide a charging location for the many USB chargeable devices in current use.

### BRIEF SUMMARY OF THE INVENTION

In accordance with a preferred embodiment of the present invention, there is shown an LED light assembly having a base with an aperture for affixation to a vehicle, a recessed pocket in the base for insertion of a removable light module with LED light, the light module has a pivoting clip for engagement to a front portion of the base, the module has a magnetic extension for engagement to metal, and the LED light is controllable through buttons on the face of the module.

In accordance with another preferred embodiment of the present invention, there is shown an LED light assembly having a base having an aperture for affixation to a vehicle, the base has a pocket for insertion of a removable light module, the light module has an extension for removable engagement to the base, the module has a pivoting flap for pivotal engagement to the LED module; and USB ports in the face of the module that are electrically connected to a power source

In accordance with yet another embodiment of the invention there is shown an LED light assembly having a base having an aperture for affixation to a vehicle and electrical engagement to a power source, the base has a recessed portion for insertion of a removable light module, the light module has a clip for engagement to the base, the module has a magnetic extension, and the body has a USB port.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a housing and detachable magnetic LED in accordance with a preferred embodiment of the invention.

FIG. 2 is a perspective view of a removable LED light module in accordance with a preferred embodiment of the invention.

FIG. 3 is a perspective view of a base with USB ports for a detachable magnetic LED housing in accordance with a preferred embodiment of the invention.

FIG. 4 is a top plan view removable LED light module in accordance with a preferred embodiment of the invention.

FIG. 5 is a perspective view of a removable LED light module elevation view of a Detachable Magnetic LED Housing.

FIG. 6 is a front elevation view of a removable LED light module in accordance with a preferred embodiment of the invention.

FIG. 7 is a side elevation view of a removable LED light module in accordance with a preferred embodiment of the invention.

FIG. 8 is a plan view of an extension for a removable LED light module in accordance with a preferred embodiment of the invention.

FIG. 9 is a side elevation view of an extension for a removable LED light module in accordance with a preferred embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for later filed claims and as a representative basis for teaching one skilled in the art to employ the present invention in virtually any appropriately detailed system, structure or manner.

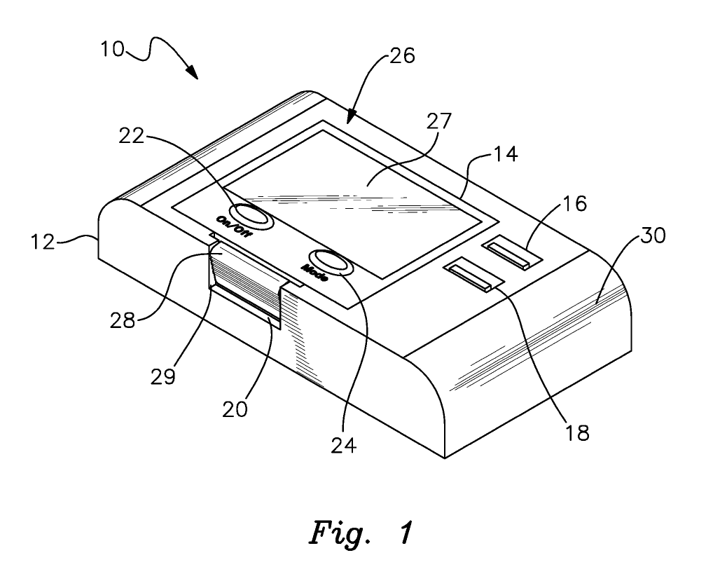

Turning now to FIG. 1, there is shown an assembly body 10 that comprises a removable LED module 26 having a screen 27 with on/off button 22 and mode button 24. Module 26 fits into a recessed pocket 45 (Shown in FIG. 3) of body 10 and is removably engaged by clip 28 that engages a lip 29 at extension 20. Situated on the face of body 10 are two Universal Serial Bus or USB ports 16 and 18. Behind lens 27 are one or more LED lights that emit visible light through lens 27. Lens 27 may preferably be made of a polycarbonate material for strength and durability. LED lights may preferably be CREE LED lighting for optimal performance.

The USB may be of any variety of generations or configurations including standard format, mini, and micro sizes, and of any of a variety of generations in current use.

Opposing ends of body 10 are rounded shoulders 12 and 30 for attractive and easy attachment to sidewalls of an interior trunk, truck bed, or other vehicle surface. Body 10 and module 26 may be made via ABS injection molding or other known methods.

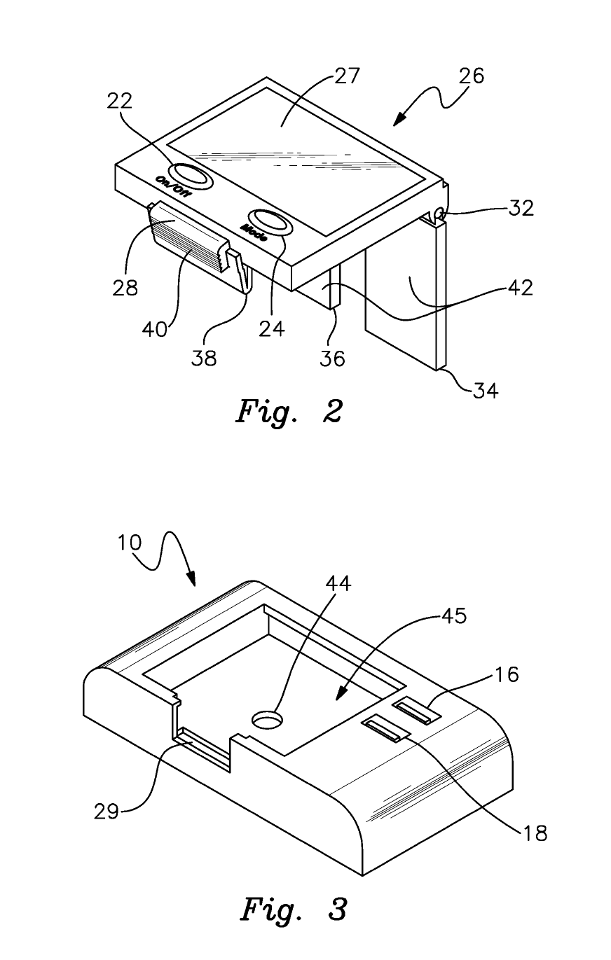

FIG. 2 shows a perspective view of removable LED module 26 having pivoting extension 34 that is pivotally engaged to removable LED module 26 via axis 32. Extension 34 may comprise magnetic material and may be attached to metal for mounting in other locations on a vehicle. Extension 34 has two legs 42 that create an easel stand with removable LED module 26 after removal from recessed pocket 45. Clip 28 has a knurled surface 40 that permits easy depression and disengagement from lip 29. Clip 28 has a V-shaped extension that permits flexing of clip 28 for attachment and removal from body 10.

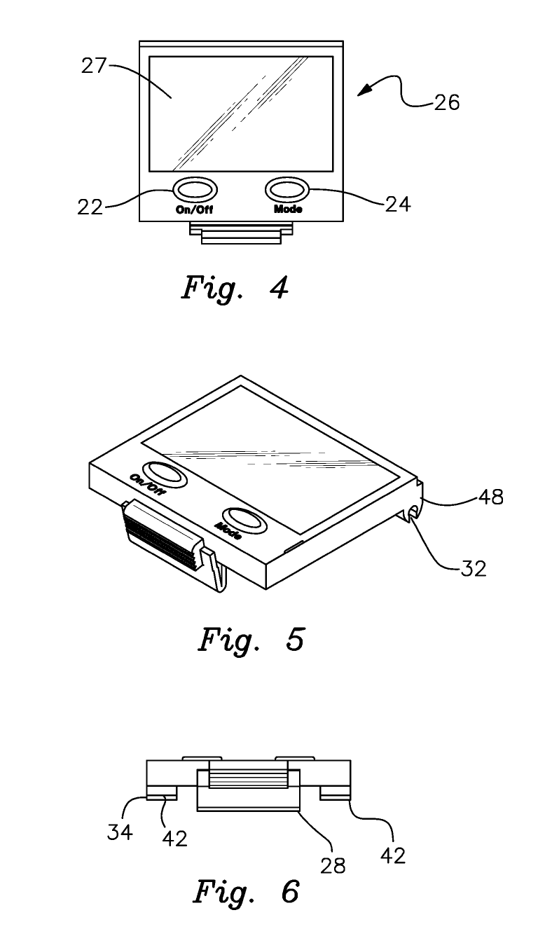

FIG. 3 shows body 10 with removable LED module 26 removed and exposes aperture 44 for placement of a fastener such as a screw for attachment of body 10 to the vehicle or other location. FIG. 4 shows a top down plan view of removable LED module 26 with on/off button 22 and mode button 24. On/off button controls electrical power to the LED lights in removable LED module 26. Power is provided to removable LED module 26 via a hard wire to the vehicle electrical system, or other external power source. It may also have a rechargeable battery in removable LED module 26 that permits power to be applied even when it is removed from body 10. This provides for easy use of the light in other locations for spot lighting, or emergency lighting purposes described below.

Mode button 24 toggles the operation of the LED lights from a steady white light, to flashing light, an amber/orange caution light, and a strobe light depending on the color and number of LED lights in removable LED module 26. The LED lights may be configured and programmed in any of a variety of ways to achieve the desired modes and lighting effects.

FIG. 5 shows in more detail the axle opening for extension 34 and its engagement to removable LED module 26. FIG. 6 shows an elevation view of removable LED module 26 and an end view of extension 34 with its two legs 42. Clip 28 is shown in elevation view and is extended farther downward than legs 42 when legs 42 are in retracted position. This permits attachment of clip 28 and stable engagement of removable LED module 26 within recessed area 45 within body 10.

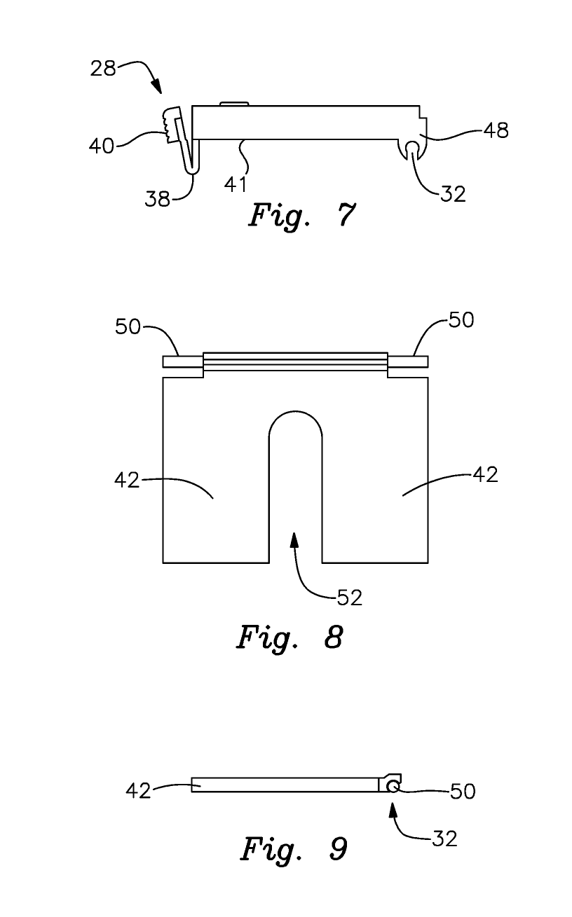

FIG. 7 shows clip 28 in side view with knurled surface 40 and pivot 38. Pivot 38 is fixedly engaged to the bottom surface 41 of removable LED module 26 and may be attached by conventional means including molding, glue, heat fusing and the like. Situated on the back lower side of removable LED module 26 axle pocket 32 is positioned below axle mount 48 as an integral part of removable LED module 26. Axle 50 more clearly shown in FIG. 8 is connected to extension 34 and may be rotatably secured in axle pocket 32 to permit pivoting of extension 34. Opening 54 is provided between legs 42 for further mounting possibilities when removable LED module 26 is removed. For example, opening 54 may be slid over a post or other extension such as a bolt or screw for stable mounting and positioning during use when removable LED module 26 is removed from body 10.

FIG. 9 is a side view of extension 34 and on its legs 42 with pin 50 shown slotted into pocket 32.

In operation, the removable LED module 26 may be used as a side light in the trunk or bed of a truck, or removed and used to provide task lighting. The USB mounts are electrically connected or harnessed to the vehicle power through the dome light circuit and may provide charging locations for other devices, such as phones, tablets, pads or any other electrical device that utilizes a USB extension for power. For example, when one has a flat tire, the removable LED module 26 may be used like a flashlight and magnetically mounted to the quarter panel.

The LED lights in removable LED module 26 may also be integrated into the vehicle dome light and turn on and off when opening the doors. Alternatively, removable LED module 26 may be integrated to the tail light to provide an additional signal light or braking light at the end of a trailer or other vehicle extension.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the later issued claims.

1. An LED light assembly comprising:
a. a base having an aperture for affixation to a vehicle;
b. a recessed pocket in the base for insertion of a removable light module with LED light;
c. the light module has a pivoting clip for engagement to a front portion of the base;
d. the module has a magnetic extension for engagement to metal; and
e. the LED light is controllable through buttons on the face the module.

2. An LED light assembly as claimed in claim 1 further comprising knurled surface on the clip.

3. An LED light assembly as claimed in claim 1 further comprising a USB port.

4. An LED light assembly as claimed in claim 1 wherein the light module has a pivoting extension for standing up the module like an easel.

5. An LED light assembly as claimed in claim 1 wherein the body is electrically connected to a vehicle power source or battery.

6. An LED light assembly as claimed in claim 1 wherein the light module has a rechargeable battery.

7. An LED light assembly comprising:
a. a base having an aperture for affixation to a vehicle;
b. the base has a pocket for insertion of a removable light module;
c. the light module has an extension for removable engagement to the base;
d. the module has a pivoting flap for engagement to the LED module; and
e. USB ports in the face of the module electrically connected to a power source.

8. An LED light assembly as claimed in claim 7 further comprising a two legged pivoting extension on the module.

9. An LED light assembly as claimed in claim 8 wherein the extension is axially engaged to a cylindrical pocket on the removable light module.

10. An LED light assembly as claimed in claim 7 wherein the clip has a knurled surface.

11. An LED light assembly as claimed in claim 7 wherein the light module has a plurality of LED lights in different colors.

12. An LED light assembly as claimed in claim 7 wherein the light module is controllable through a button on the front face of the module.

13. An LED light assembly as claimed in claim 7 wherein the light module has a plurality of modes showing different colored light.

14. An LED light assembly comprising:
a. a base having an aperture for affixation to a vehicle and electrical engagement to a power source;
b. the base has a recessed portion for insertion of a removable light module;
c. the light module has a clip for engagement to the base;
d. the module has a magnetic extension; and
e. the body has a USB port.

15. An LED light assembly as claimed in claim 14 further comprising a rechargeable battery in the light module.

16. An LED light assembly as claimed in claim 14 further comprising an electrical connection to a battery.

17. An LED light assembly as claimed in claim 14 further comprising an on/off button on the surface of the module.

18. An LED light assembly as claimed in claim 14 wherein the extension has two legs and space between the legs.

19. An LED light assembly as claimed in claim 14 further comprising a clip having a pivoting V-shaped connection to the module.

20. An LED light assembly as claimed in claim 14 further comprising a flashing mode for the LED light.
